(19) United States
(12) Patent Application Publication
(10) Pub. No.: US 2014/0049642 A1
(43) Pub. Date: Feb. 20, 2014

(54) GAS MONITORING SYSTEM AND GAS MONITOR

(71) Applicants: Yunshao Jiang, Shenzhen (CN); Chunhao Wu, Shenzhen (CN); Kunhsien Lin, Shenzhen (CN); Yongqiang Wang, Shenzhen (CN); Zhiyou Shu, Shenzhen (CN)

(72) Inventors: Yunshao Jiang, Shenzhen (CN); Chunhao Wu, Shenzhen (CN); Kunhsien Lin, Shenzhen (CN); Yongqiang Wang, Shenzhen (CN); Zhiyou Shu, Shenzhen (CN)

(21) Appl. No.: 13/637,990

(22) PCT Filed: Aug. 27, 2012
(86) PCT No.: PCT/CN12/80614

§ 371 Date: Sep. 28, 2012

(30) Foreign Application Priority Data
Aug. 14, 2012 (CN) 201220402265.0

(51) Int. Cl. G08B 17/10; H04N 7/18

(52) U.S. Cl. 348/144; 340/632; 348/E07.085

(57) ABSTRACT

A gas monitoring system and a gas monitor includes a remote control aircraft, a gas detection device, and a wireless transmission device. The remote control aircraft includes an airframe and a flight controller, and the gas detection device and the wireless transmission device are arranged on the airframe.

### TECHNICAL FIELD

The present disclosure relates to the gas leakage monitoring field, and more particularly to a gas monitoring system and a gas monitor.

### BACKGROUND

At present, various chemical gases are used when manufacturing liquid crystal display (LCD) panels by an LCD panel production line, such as HF, SiH₄, NF₃, NH₃, H₂, CL₂ and N₂. HF, CL₂, and NH₃ are toxic gases, and SiH₄, NF₃, NH₃, and H₂ are inflammable gases. Staff may be injured or explosions may happen once these gases leak. Thus, it is necessary to monitor the LCD production line for the leakage of gas, to find gases leakages in time and reduce damage and loss. One typical gas leakage monitoring method mainly includes two methods: the first method includes fixedly arranging gas monitoring equipment at one point or multiple points. The disadvantage of the first method is that it lacks flexibility, has dead zones, and is unable to meet the requirement of omnidirectional monitoring. The second method includes arranging a portable monitoring car on the ground. Though the monitoring car can move within large ranges, it is unable to detect the gas at high altitudes because it can only move on the ground, and monitored dead zones also exist because some gases float in the air because the gases have a density less than density of air.

### SUMMARY

In view of the above-described problems, the aim of the present disclosure is to provide a gas monitoring system and a gas monitor capable of meeting the requirement of omnidirectional monitoring.

A first technical scheme of the present disclosure is that: a gas monitor, comprising:

a remote control aircraft that is used as a carrier;

a gas detection device that detects gas information; and

a wireless transmission device that processes and wirelessly transmits detected gas information.

The remote control aircraft comprises an airframe and a flight controller, and the gas detection device and the wireless transmission device are arranged on the airframe.

The gas detection device is a toxic gas detection device; and The gas detection device is further an inflammable gas detection device.

The gas monitor further comprises a camera, and the wireless transmission device is connected with the camera to wirelessly transmit video or images from camera.

The airframe is configured with a distance sensor that detect distance between the airframe and outside object(s), and the distance sensor is connected with the flight controller.

A second technical scheme of the present disclosure is that: a gas monitor, comprising:

a remote control aircraft that is used as a carrier;

a gas detection device that detects was information; and

a wireless transmission device that processes and wirelessly transmits gas information detected.

The remote control aircraft comprises an airframe and a flight controller, and the gas detection device and the wireless transmission device are arranged on the airframe.

In one example, the gas detection device is a toxic gas detection device.

In one example, the toxic gas detection device detects HF, CL₂, or NH₃.

In one example, the gas detection device is an inflammable gas detection device.

In one example, the inflammable gas detection device detects SiH₄, NF₃, NH₃, or H₂.

In one example, the has monitor further comprises a camera, and the wireless transmission device is connected with the camera to wirelessly transmit video or images from the camera. The camera captures the site images and video, and help handler(s) look for gas leakage point and gas leakage reason in time when chemical gases leak, so that the handler masters more related information before entering the accident site, thereby reducing accident handling time and reducing danger level for people. In addition, the camera also is used as an eye of a remote control person, to achieve visual control, and the distribution of objects around the remote control aircraft can be seen through the camera, to facilitate the remote control person to control the remote control aircraft so as to avoid air crashes caused by collision.

In one example, the airframe is configured with a distance sensor that detects the distance between the airframe and outside object(s), and the distance sensor is connected with the flight controller. When the distance between the airframe and the object around the airframe is less than a set safe distance, the flight controller automatically controls the remote control aircraft to stop continuously moving to the direction, thereby increasing safety, and avoiding air crashes caused by collision.

In one example, the gas monitor comprises a radio frequency (RF) remote control, and the flight controller obtains control commands through the RF remote control.

A third technical scheme of the present disclosure is that: a gas monitoring system comprises the aforementioned gas monitor, a wireless signal receiving device, and a remote computer service desk. The remote computer service desk obtains information monitored by the gas monitor through a wireless local area network (LAN) and the wireless signal receiving device.

In one example, two-way communication is performed between the remote control aircraft and the remote computer service desk, and the remote computer service desk sends control commands to the remote control aircraft through the wireless local area network (LAN).

Advantages of the present disclosure are summarized as follows: the gas monitor of the present disclosure comprises a remote control aircraft, a gas detection device, and a wireless transmission device. The remote control aircraft is used as a carrier to transport the gas detection device and the wireless transmission device to each monitoring position. The remote control aircraft in the prior art can meet the requirement of omnidirectional monitoring and has no monitoring dead zones because the remote control aircraft can fly over roofs, fly at low altitude, and can even hover. The wireless transmission device can wirelessly transmit the information result detected by the gas detection device to long distances, so that gas leakage information can be obtained from long distance without waiting for recovery of the remote control aircraft, and alarm signal(s) can be sent out in time to inform relevant personnel to analyze the resaon and handle gas leakage once the gas leakage is detected.

### BRIEF DESCRIPTION OF FIGURES

FIG. 1 is a schematic diagram of an example of a gas monitoring system of the present disclosure; and

FIG. 2 is a structure diagram of an example of to gas monitor of the present disclosure.

### DETAILED DESCRIPTION

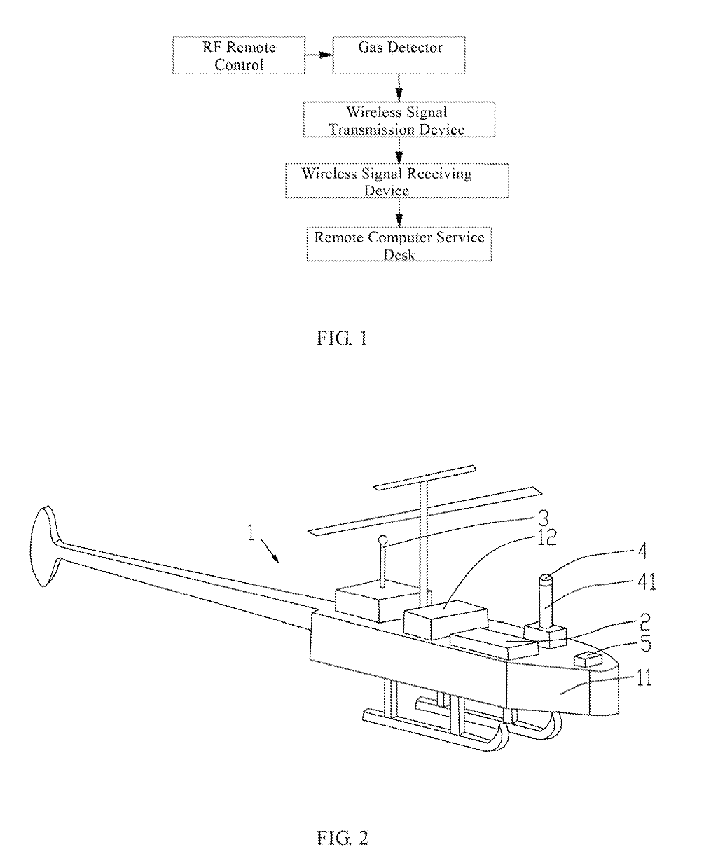

The present disclosure provides a gas monitor and a gas monitoring system. FIG. 1 shows an example of the gas monitoring system, comprising: a gas monitor, a wireless signal receiving device, and a remote computer service desk. The remote computer service desk obtains information monitored by the gas monitor through a wireless local area network (LAN) and a wireless signal receiving device. Handler masters site conditions by the remote computer service desk to take reasonable measures, and controls the gas monitor by the remote computer service desk.

FIG. 2 shows an example of the gas monitor of the aforementioned gas monitoring system, comprising:

a remote control aircraft 1 that is used as a carrier;

a gas detection device 2 that detects gas information; and

a wireless transmission device 3 that processes and wirelessly transmits the detected gas information.

The remote control aircraft 1 comprises an airframe 11 and a flight controller 12, where the gas detection device 2 and the wireless transmission device 3 are arranged on the airframe 11.

The gas monitor of the present disclosure comprises a remote control aircraft 1, a gas detection device 2, and a wireless transmission device 3. The remote control aircraft 1 is used as a carrier to transport the gas detection device 2 and the wireless transmission device 3 to each monitoring position. The remote control aircraft 1 in the prior art meets the requirement of omnidirectional monitoring and has no monitored dead zones because the remote control aircraft can fly over roofs, fly at low altitudes, and even hover. The wireless transmission device 3 can wirelessly transmit the information result detected by the gas detection device 2 long distances, so that gas leakage information can be obtained from long distance without waiting for recovery of the remote control aircraft 1 and alarm signal(s) can be sent out in time to inform relevant personnel to analyze the reason and handle gas leakage once the gas leakage is detected.

In the example, the corresponding gas detection device 2 is arranged on the gas monitor in accordance with gas(es) actually used in the production field. The gas detection device 2 may be a toxic gas detection device that detects one or more of HF, CL₂ and N₂, and maybe an inflammable gas detection device that detects one or more of SiH₄, NF₃, NH₃ and H₂. If two kinds of gases are used together, both the toxic gas detection device and the inflammable gas detection device maybe arranged on the airframe 11.

In the example, the gas monitor 1 further comprises a camera 4. The wireless transmission device 3 is connected with the camera 4 to wirelessly transmit images and video from the camera. The camera 4 captures the site images and video, and can help handler(s) look for gas leakage point and gas leakage reason in time when chemical gases leak, so that the handler can master more related information before entering the accident site, thereby reducing accident handling time and reducing danger level for people. In addition, the camera 4 also is used as an eye of a remote control person, to achieve visual control, and the distribution of objects around the remote control aircraft 1 can be seen through the camera 4, to facilitate the remote control person to control the remote control aircraft 1 so as to avoid air crashes caused by collision.

To increase visual direction and range of the camera 4, in the example, the camera 4 is specially configured with a rotary bracket 41, and the camera 4 is driven to rotate by the rotary bracket 41, to observe the conditions of all directions. Thus, it is not necessary to completely depend on the rotation of the remote control aircraft 1.

In the example, the airframe is configured with a distance sensor 5 that detects distance between the airframe 11 and outside object(s), and the distance sensor 5 is connected with the flight controller 2. When the distance between the airframe 11 and the object around the airframe is less than a set safe distance, the flight controller 2 automatically controls the remote control aircraft 1 to stop continuously moving to the direction, thereby increasing safety, and avoiding air crash caused by collisions.

The remote control aircraft 1 of the gas monitor of the present disclosure can also be controlled by a radio frequency (RF) remote control, and the flight controller 12 obtains control commands through the RF remote control. The remote control aircraft 1 of the present disclosure can be directly modified by a toy remote control aircraft, and can also be modified by an aviation aircraft model.

In the present disclosure, if two-way communication is performed between the remote control aircraft and the remote computer service desk, the remote computer service desk can send control commands to the remote control aircraft through the wireless local area network (LAN), thereby increasing the remote control distance, and achieving remote control.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A gas monitor, comprising:
a remote control aircraft that is used as a carrier;
a gas detection device that detects gas information; and
a wireless transmission device that processes and wirelessly transmits the detected gas information;
wherein the remote control aircraft comprises an airframe and a flight controller, and the gas detection device and the wireless transmission device are arranged on the airframe;
wherein the gas detection device is a toxic gas detection device;
wherein the gas detection device is further an inflammable gas detection device; wherein the gas monitor further comprises a camera, and the wireless transmission device is connected with the camera to wirelessly transmit video or images from the camera; and wherein the airframe is configured with a distance sensor that detects distance between the airframe and outside object(s), and the distance sensor is connected with the flight controller.

2. A gas monitor, comprising:
a remote control aircraft that is used as a carrier;
a as detection device that detects gas information; and
a wireless transmission device that processes and wirelessly transmits detected gas information;
wherein the remote control aircraft comprises an airframe and a flight controller, and the gas detection device and the wireless transmission device are arranged on the airframe.

3. The gas monitor of claim 2, wherein the gas detection device is a toxic gas detection device.

4. The gas monitor of claim 3, wherein the toxic gas detection device detects HF, CL₂, or NH₃.

5. The gas monitor of claim 2, wherein the as detection device is an inflammable gas detection device.

6. The gas monitor of claim 5, wherein the inflammable gas detection device detects SiH₄, NF₃, NH₃, or H₂.

7. The gas monitor of claim 2, wherein the gas monitor further comprises a camera, and the wireless transmission device is connected with the camera to wirelessly transmit video or images from the camera.

8. The gas monitor of claim 2, wherein the airframe is configured with a distance sensor that detects distance between the airframe and outside object(s), and the distance sensor is connected with the flight controller.

9. The gas monitor of claim 2, wherein the gas monitor comprises a radio frequency (RF) remote control, and the flight controller obtains control commands through the RF remote control.

10. A gas monitoring system, comprising:
a gas monitor;
a wireless signal receiving device; and
a remote computer service desk, wherein the remote computer service desk obtains information monitored by the gas monitor through a wireless local area network (LAN) and a wireless signal receiving device; the gas monitor, comprising:
a remote control aircraft that is used as a carrier;
a gas detection device that detects gas information and
a wireless transmission device that processes and wirelessly transmits detected gas information;
wherein the remote control aircraft comprises an airframe and a flight controller, and the gas detection device and the wireless transmission device are arranged on the airframe.

11. The gas monitoring system of claim 10, wherein two-way communication is performed between the remote control aircraft and the remote computer service desk, and the remote computer service desk sends control commands to the remote control aircraft through the wireless local area network (LAN).
